(19) United States
(12) Patent Application Publication
(10) Pub. No.: US 2026/0065349 A1
(43) Pub. Date: Mar. 5, 2026

(54) MULTI-LEVEL INTENDED PURPOSE RECOMMENDATIONS BASED ON IMAGE DATA

(71) Applicant: Walmart Apollo, LLC, Bentonville, AR (US)

(72) Inventors: Girish Vasvani, Mountain House, CA (US); Seema Chaudhry, Woodside, CA (US); Om Prakash Ghanta, Sunnyvale, CA (US)

(21) Appl. No.: 19/318,149

(22) Filed: Sep. 3, 2025

Related U.S. Application Data
(60) Provisional application No. 63/690,499, filed on Sep. 4, 2024.

(51) Int. Cl. G06Q 30/0601

(52) U.S. Cl. CPC G06Q 30/0631; G06Q 30/0643

(57) ABSTRACT

Examples include identifying a primary item from an initial query and item attributes associated with the primary item; obtaining an image and identify setting details associated with a setting depicted in the image using a computer vision (CV) model; determining, using a machine learning (ML) model, a micro-level intent and a macro-level intent for the primary item; selecting, using the ML model, a plurality of recommended items for use in conjunction with the primary item, wherein the plurality of recommended items includes at least one micro-item belonging to a same or similar item-type as the primary item selected based on the micro-level intent and at least one macro-item belonging to an item-type outside of the item-type of the primary item selected based on the macro-level intent; and presenting each of the plurality of recommended items as a selectable option for including in a selection experience including the primary item.

### BACKGROUND

When searching for a product or service using a traditional search engine associated with a retail store or online shopping, a customer typically enters a query such as, “big screen television” or “living room sofa.” Search engines typically present the customer with a wide variety of televisions or sofa product entries in response to these types of queries. However, the search results are typically very broad and sometimes may be unhelpful to the user, requiring the user to attempt multiple different search queries to find a desired item. Moreover, the customer may require multiple different types of items to be used in conjunction with the desired item for which the user is searching. In the above example, the user may need or want speakers, sofa cushions, a television mounting device for hanging the television on the wall, etc. In such cases, the user may become frustrated with the time-consuming process of searching for each related item one at a time. Moreover, the retail facility may lose potential sales for related items and services available from the retail provider of which the customer may be unaware. Thus, the current shopping experience for users can frequently be slow and tedious while providing limited or undesired search results which are only minimally helpful to the customer resulting in customer dissatisfaction and lost revenues for the retailer.

### BRIEF DESCRIPTION OF THE DRAWINGS

FIG. 1 is an exemplary block diagram illustrating a system for providing intent-based shopping guidance using augmented search results and augmented images of recommended items in an intended setting.

FIG. 2 is an exemplary block diagram illustrating a system for providing intent-based search filter recommendations, augmented reality (AR) images of recommended items, and augmented search results.

FIG. 3 is an exemplary block diagram illustrating a guidance manager component for generating augmented search results for intent-based shopping guidance.

FIG. 4 is an exemplary block diagram illustrating a guidance manager component workflow.

FIG. 5 is an exemplary flow chart illustrating operation of the computing device to generate augmented search results for use in providing enhanced shopping guidance to customers.

FIG. 6 is an exemplary flow chart illustrating operation of the computing device to generate intent-based filter suggestions for use in refining search results for an improved shopping experience.

FIG. 7 is an exemplary screenshot illustrating a guided shopping page having prompt suggestions for filtering a search query into a more refined search query.

FIG. 8 is an exemplary screenshot illustrating a guided shopping page having iterative filtering suggestions for further refining a search query.

FIGS. 9A and 9B are exemplary screenshots illustrating an intended setting modified image including a primary item and a recommended item represented within a user-selected intended setting.

FIG. 10 is an exemplary screenshot illustrating recommended items with location information for the recommended items.

FIG. 11 is an exemplary screenshot illustrating initial search results with recommended filters for refining the search results based on intended purpose of the primary item.

FIG. 12 is an exemplary screenshot illustrating recommended items consistent with a predicted intended purpose of one or more items in a customer basket.

FIG. 13 is an exemplary screenshot illustrating recommended items consistent with a predicted intended purpose of a primary item being viewed on a search results page.

FIG. 14 is an exemplary screenshot illustrating additional recommended items consistent with a predicted intended purpose of one or more items scanned by a customer via a shopping application.

FIG. 15 is a flowchart illustrating a method for generating multi-level intended purpose item recommendations.

FIG. 16 is a flowchart illustrating a method for generating a modified image depicting a primary item and recommended items in an intended setting.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Customers frequently purchase many different types of products and services as part of a bigger picture to address a specific job the customer wants done or a goal the customer is trying to achieve. A job is a key event, occasion, activity, interest, lifestyle goal, or other intended purpose of the user. A job can include preparing for a dinner, watching a sporting event with friends, decorating a new home, upgrading the furniture and electronics in a home or specific room in a home, throwing a party, obtaining needed items for a new hobby, decorating for a holiday, or any other type of job. Over time, some items can become obsolete as trends, fashion and technology changes. Therefore, jobs are agnostic to specific items (products and/or services).

For example, a customer searching for a television is typically interested in a micro-level goal of streaming and binge watching television shows and movies. To achieve this, the customer requires more than just a television. The customer may need a specific type of smart television capable of connecting to a streaming service, a comfortable sofa to sit on, and a streaming service subscription. On a macro-level, this goal may also be part of a living room upgrade/setup or moving into a new home. However, when searching in a traditional search engine associated with a retail provided for a television, the retail provider has no way of knowing the intended purpose of the search query.

Some current solutions provide long lines of product recommendations responsive to search queries that are presented on a carousel of product entries through which the user can scroll. These endless lines of product recommendation carousels are frequently sprinkled across various webpages and touch points encountered during a customer's shopping journey via a retail webpage or shopping-related application, such as banners on a home page, carousels on category or other marketing pages, carousels associated with a customer cart, checkout, my account page, marketing emails, etc. These long lines of products are presented in the hope that one or more products will help with whatever job the customer has in their minds. Not only can this lead to customers feeling overwhelmed by the recommendation carousels chasing them everywhere they go, but the retailers also fail to learn about the intended job the customer is trying to achieve.

Without specific knowledge of a user's intended purpose for a product the user is searching for, it is difficult, if not impossible, for a retailer to anticipate other related items and services which the user is likely to also need or want in conjunction with the item that is primarily being sought via the search query to get a job done or achieve a goal (intended purpose). This is a gap in current product search systems and product catalogs results in failure to meet all customer needs for a desired job as well as failing to provide accurate predictive recommendations for assisting a user in meeting their goals.

Referring to the figures, examples of the disclosure enable intent-based shopping guidance for improving a shoppers retail journey. In some examples, a guidance manager analyzes user-specific data, including the user's purchase history and user-profile data, to provide filter suggestions for filtering search results in accordance with the user's intended purpose. The intended purpose is the reason for the search or the reason the user is searching for a specific item (primary item). The intended purpose can include a micro-level goal related to narrow and specific reason for the search, and also a macro-level goal related to a broader, “big picture” reason for the search. The search is performed to locate and obtain one or more items and/or services to assist the user in completing a job, task, or achieving a goal. The recommended filters assist the user in more quickly finding the primary item and identifying one or more other recommended items which may be needed or wanted for use in conjunction with the primary item. The recommended items assist the user in completing the job to be done (JTBD). The filters assist the user in locating the desired item by narrowing the search query. This further reduces system resource usage, such as processor and network bandwidth which is being consumed during the search.

Other embodiments enable a guidance manager that assists the user in curating search results in accordance with the user's intended purpose associated with the JTBD. The curated search results are augmented with suggested filter terms for further refining the search, additional recommended items, promotional offers for the recommended items, and other related information to assist the user in achieving their goal while providing the best deals and selection of complementary items for completing the JTBD. The augmented results are presented to a user via a user interface (UI) device. This further enables reduced processor usage, reduced memory usage, reduced network bandwidth usage, as well as improved user interaction via the UI device and increased user interaction performance via the UI.

Aspects of the disclosure further enable an intent-based search guidance with augmented results for an improved online shopping journey. The computing device operates in an unconventional manner by integrating generative artificial intelligence (AI) into the product and services search features enabling enhancement of the search results with augmented search related information to assist the user in locating items and services predicted to assist with performing a job to be done. A guidance manager augments the search results to include intent-based filters, recommended items to be used in conjunction with a primary item being searched for, as well as augmented reality images of an intended setting for utilization of the primary item and/or any recommended items. In this manner, the computing device is used in an unconventional way, and allows improved search efficiency, provision of augmented search results, generation of predictive visual images representing the predicted appearance and locations of items in a user-selected setting, as well as reduced system resource usage, thereby eliminating existing catalog search limitations associated with retail shopping, as well as improving the underlying functioning of the underlying computing device.

In other embodiments, the system uses AI and/or AR to augment images of a user-selected setting or environment in which a primary item is likely to be used to include images of the primary item as well as other additional recommended items which are predicted to be needed or wanted by the user to perform a JTBD. The intended setting AR images are presented to the user with the augmented search results and/or while viewing curated search results provided to the user by the system as part of the improved shopping guidance. The AR images enable the user to see a visual of the items in a room or other location where the user plans to use the items. This assists the user in making a purchase determination as well as reduces customer dissatisfaction after purchase, further reducing the number of product returns occurring after purchase.

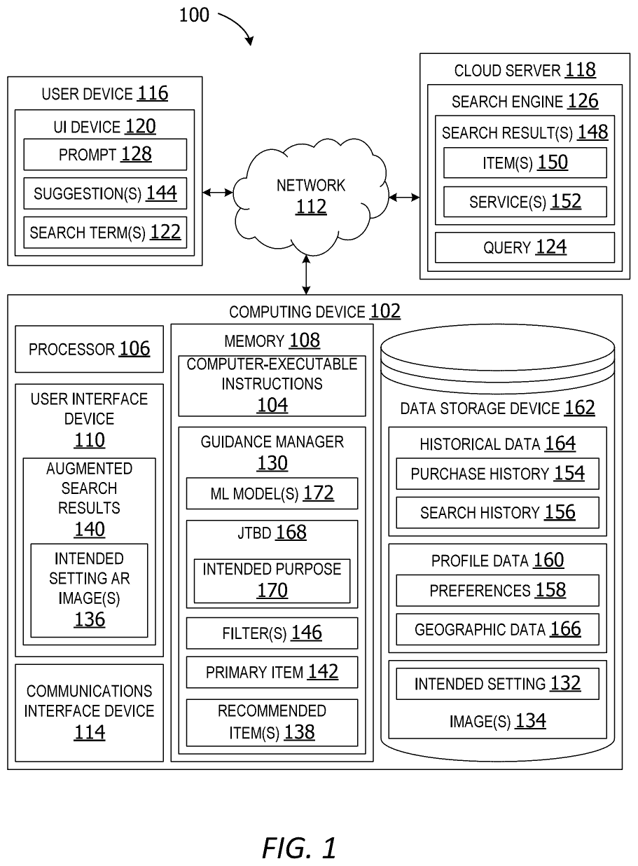

Referring again to FIG. 1, an exemplary block diagram illustrates a system 100 for providing intent-based shopping guidance using augmented search results and augmented images of recommended items in an intended setting. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

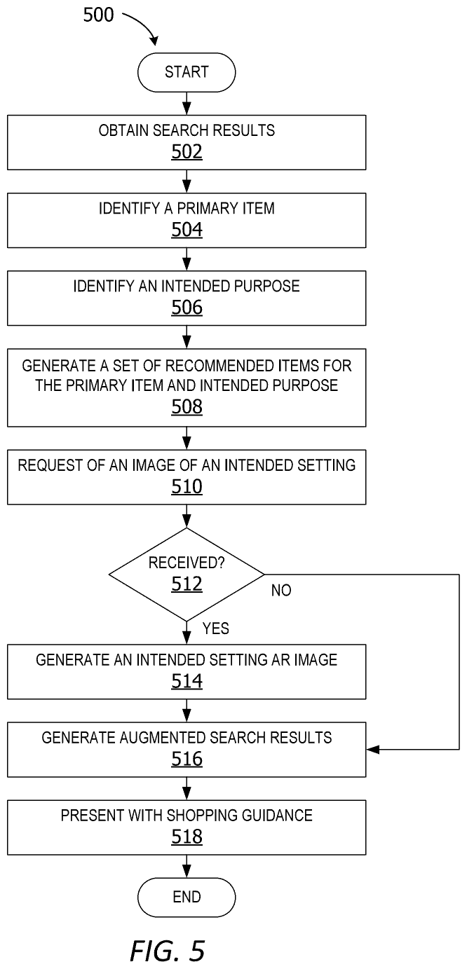

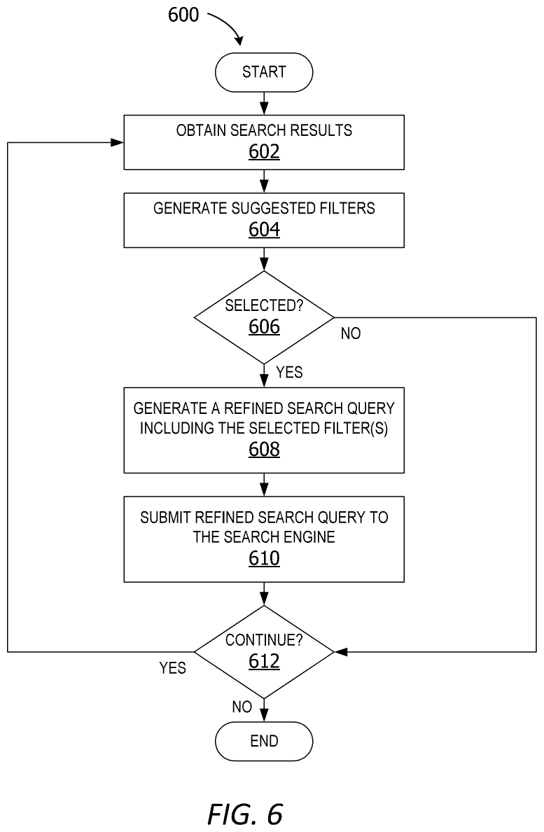

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 5, and FIG. 6).

The computing device 102 further has one or more computer-readable media, such as the memory 108. The memory 108 includes any quantity of media associated with or accessible by the computing device 102. The memory 108, in these examples, is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to, a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) device 120. The UI device 120 is a device for presenting data to a user and/or receiving data from a user, such as, but not limited to, the user interface device 110.

In this example, a user utilizes the UI device 120 to generate search term(s) 122 associated with a query 124 to a search engine 126. The search term(s) 122 include one or more search terms for searching a catalog of products and/or services, such as an online shopping database of entries associated with items available for sale or lease from a retailer. In this example, the search engine 126 is hosted on the cloud server 118. However, the examples are not limited to a search engine on a cloud server. In other examples, the search engine can be hosted on a computing device, such as, but not limited to, the computing device 102.

The search term(s) 122 include one or more words or phrases associated with a primary item 142 the user wants to find. The primary item 142 is the target or primary object of the search. For example, if the user wants to purchase a television, the search term(s) 122 might include the words “big screen tv.” If the user wants to purchase living room furniture, the search term(s) 122 might include the words “living room suite” or “sectional sofa” or “living room set.” The query 124 submitted to the search engine includes the search term(s) 122 provided by the UI device 120 and transmitted via the network.

The UI device 120 provides data to the user from the guidance manager 130. The guidance manager 130 provides an enhanced intent-based shopping experience to the user. In some embodiments, the guidance manager provides a prompt 128 to the user to enter or provide information to the guidance manager 130. For example, the guidance manager 130 can prompt the user to provide an image of an intended setting or other environment where the user plans to use the primary item 142 being searched for via the search engine 126. If the user provides one or more image(s) 134 of the intended setting 132, the guidance manager 130 uses the image(s) 134 to create intended setting augmented reality (AR) image(s) 136 showing a visualization of the primary item 142 and/or one or more other recommended item(s) 138 within the intended setting 132. The intended setting AR image(s) 136 are included in augmented search result(s) 140 provided to the user as part of the enhanced shopping journey. This enables the user to visualize what the items are likely to look like if the user chooses to purchase the items and place them in the intended setting. In the above example, if the user is searching for a television or living room furniture for the living room of the user's home, the user can provide one or more image(s) 134 of the living room. The guidance manager 130 can then augment those image(s) 134 to include AI or AR images of the primary item 142 and/or the one or more recommended item(s) 138 placed at one or more locations within the intended setting. In this manner, the user can see what the television or furniture might look like if purchased and placed in the living room, as intended by the user.

In other embodiments, the guidance manager 130 presents one or more suggestion(s) 144 to the user via the UI device 120. The suggestion(s) 144 include recommendations for one or more filter(s) 146 for further refining the search result(s) 148 generated by the search engine 126. A filter is a search term or phrase used in a refined search query to further refine or filter the initial or previous search results. The filter terms enable the user to refine the search results or more narrowly focus the search results to obtain recommendations for item(s) 150 and/or service(s) 152 which are more likely to be needed or wanted by the user. In other words, the filter(s) enable the user to narrow the search result(s) 148 to obtain more targeted item and service recommendations that the user is most likely to need or want in order to perform the job to be done, such as achieving a goal, completing a task, etc. In an example, if the job is to redecorate the living room, the filter(s) 146 are selected which are most likely to assist the user in locating living room furniture and decorations that are predicted to be desired by the user based on the intended purpose of the search, the user's historical purchase history 154, search history 156, the user' preferences 158 found in the user's profile data 160, and/or other user-specific information. The user-specific information includes membership information, purchase history, browsing history, and/or location information. The location information can include the city, state, climate, housing style, contact center history, as well as any other type of user-specific information.

In still other embodiments, the suggestion(s) 144 include suggested recommended item(s) 138 recommended for purchase with the primary item 142, suggested promotional offers and discounts, suggestions regarding sponsored items, suggestions regarding optimal placement of items within the intended setting, suggestions regarding set-up or installation of items, suggestions regarding service providers, as well as any other suggestions for enhancing a customer's retail shopping experience.

The cloud server 118 is a logical server providing services to the computing device 102 or other clients, such as, but not limited to, the user device 120. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The system 100 can optionally include a data storage device 162 for storing data, such as, but not limited to historical data 164, the profile data 160, and/or the image(s) 134. However, the embodiments are not limited to the types of data shown in FIG. 1. In other examples, the data storage device 162 stores other data in addition to or instead of the types of data shown here. For example, the data storage device 162 optionally stores the intended setting AR image(s) 136 generated by the guidance manager 130, the suggestion(s) 144, filter(s) 146, catalog data associated with a catalog of items and/or services offered for sale by a retailer, as well as any other type of data.

The historical data 164 includes any type of historical data associated with the user. The historical data 164 in this example includes purchase history 154 data describing items and/or services previously purchases by a user and/or search history 156. The search history 156 includes data associated with previous searches performed by the user. The search history 156 includes previous search queries and filter(s) submitted by the user via the user device, such as, but not limited to, the search query 124.

The profile data 160 includes user-provided data associated with a user. The profile data 160 in this example includes user preferences. The user preferences 158 can include food preferences, style preferences, color preferences, preferences associated with offers, discounts, and special promotions, or any other type of user-specific data. The profile data 160 can optionally also include geographic data 166. The geographic data 166 is data associated with a geographic location of the user, the user's residence, or other geographic data associated with the user. The geographic data can include an address, county, state, country or other location information. The geographic data can also include geographically-related information, such as seasonal information, local events, local weather information, etc.

The data storage device 162 can include one or more different types of data storage devices, such as, for example, one or more rotating disks drives, one or more solid state drives (SSDs), and/or any other type of data storage device. The data storage device 162 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 162 includes a database.

The data storage device 162 in this example is included within the computing device 102, attached to the computing device, plugged into the computing device, or otherwise associated with the computing device 102. In other examples, the data storage device 162 includes a remote data storage accessed by the computing device via the network 112, such as a remote data storage device, a data storage in a remote data center, or a cloud storage.

The memory 108 in some examples stores one or more computer-executable components, such as the guidance manager component. The guidance manager 130, when executed by the processor 106 of the computing device 102, identifies an intended purpose 170 associated with a JTBD 168. In some examples, the JTBD 168 is identified by one or more machine learning (ML) model(s) 172, such as, but not limited to, a generative AI model. The JTBD 168 and/or the intended purpose 170 of the primary item 142 being searched for can be determined based on the search term(s) 122 provided by the user. In some examples, the search term(s) 122 are natural language search terms that are interpreted by one or more large language models (LLMs) in the one or more model(s) 172. For example, if a user indicates that he wants a television to watch sporting events, the guidance manager 130 understands the JTBD 168 is to prepare a room, such as a living room, for viewing sporting events at home. The intended purpose 170 of the television being searched for is to watch sporting events, such as football games at home. The intended purpose 170 indicates the reason the user wants to purchase a television. However, completing the JTBD 168 may require more than just a television. For example, the user may need a cough, a speaker system, a streaming service on which the user can view live sporting events, etc.

In some embodiments, the guidance manager 130 obtains initial search results, such as the search result(s) 148 generated by the search engine 126. The initial search results include one or more item(s) 150 and/or service(s) 152 associated with an initial query 124 received from the UI device 120, in this example. The guidance manager 130 identifies the primary item 142 from the initial search results and/or the search term(s) 122. A ML model is used to select one or more recommended item(s) 138 based on the intended purpose 170 of the primary item 142 and/or user-specific data, such as, but not limited to, the historical data 164 and/or the profile data 160. The recommended item(s) 138 include at least one item or service to be used in conjunction with the primary item 142.

In some embodiments, the guidance manager 130 utilizes AI or AR to create one or more intended setting AR image(s) 136 to assist the user in visualizing what the primary item 142 and/or the recommended item(s) 138 with a user-selected setting, such as the intended setting 132. The intended setting AR image is a visual representation of the primary item and the set of recommended items being used for their intended purpose within the intended setting. For example, if the primary item is a couch, the intended setting AR image may include a visual showing the couch in the user's living room with an image of the user or some other person sitting on the couch surrounded by other items and furniture currently located in the user's living room. The intended setting AR image optionally also includes images of the recommended item(s) 138 placed at appropriate locations within the user's living room. This enables the user to make an informed decision regarding whether to purchase the primary item and/or one or more of the additional recommended item(s).

The guidance manager 130 generates augmented search results 140 responsive to the query 124 and/or any additional filter(s) applied by the user. The augmented search result(s) provide recommended items and/or services which are predicted to be wanted or needed by the user to perform the JTBD 168 in accordance with the intended purpose 170 of the primary item 142. The augmented search results 140 in some examples include the primary item 142, the set of recommended item(s) 138, and/or the intended setting AR image(s) 136. The augmented search results 140 are presented to the user via a UI, such as, but not limited to, the user interface device 110 and/or the UI device 120.

In the example shown in FIG. 1, the search engine 126 is located on a cloud server separately from the guidance manager 130 located on the computing device 102. However, in other embodiments, the search engine 126 is located on the computing device 102 with the guidance manager 130. In still other examples, the search engine 126 is incorporated into the guidance manager 130.

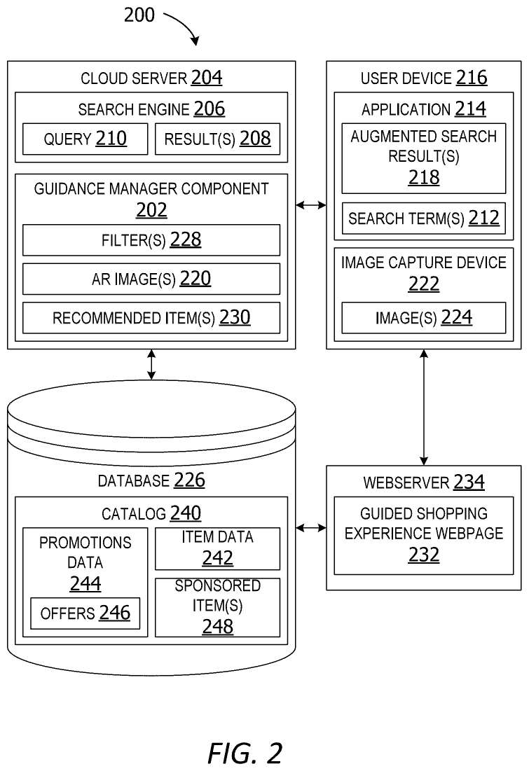

FIG. 2 is an exemplary block diagram illustrating a system 200 for providing intent-based search filter recommendations, AR images of recommended item(s) 230, and augmented search results. In this example, a guidance manager component 202 is implemented on a cloud server 204. The guidance manager component 202 is a component for providing a guided shopping experience, such as, but not limited to, the guidance manager 130 in FIG. 1. The cloud server 204 is a cloud-based server for providing services to one or more other devices via a network, such as, but not limited to, the cloud server 118 in FIG. 1.

In this example, the guidance manager component 202 and a search engine 206 for responding to user queries is located on the cloud server 204 with the guidance manager component 202. However, in other examples, the search engine 206 is located on a separate device from the guidance manager, as is shown in FIG. 1. The search engine 206 is a component for generating search result(s) 208 in response to a user-generated search query 210, such as, but not limited to, the search engine 126 in FIG. 1.

In this example, the query 210 includes one or more search term(s) 212 created via a search function on a shopping application 214 hosted on a user device 216. The user device 216 is a computing device having a processor and a memory, such as, but not limited to, the user device 116 in FIG. 1. In this example, the user logs into the application 214 to search one or more catalogs of items (products) and/or services available from a retailer. The application 214 may be utilized during online shopping or within a brick and mortar retail facility. In other examples, the search engine 206 is accessible via an application programming interface (API) utilized by the user device 216 to access the search engine 206 and/or receive augmented search result(s) 218 from the guidance manager component 202. The augmented search result(s) 218 include augmented search result(s) and/or AR image(s) 220, such as, but not limited to, the augmented search results 140 in FIG. 1.

In some embodiments, the user device 216 includes an image capture device 222 for generating one or more image(s) 224 of a user-selected setting. The image capture device 222 is any type of device for generating still digital images and/or digital video images, such as a digital camera. The user device 216 transmits the image(s) 224 of the user-selected setting to the guidance manager component 202 via a network, such as, but not limited to, the network 112 in FIG. 1. However, the embodiments are not limited to generating digital images via an image capture device on a user device. In other examples, the image(s) 224 are obtained from a data storage device, such as, but not limited to, a database 226 and/or the data storage device 162 in FIG. 1.

The guidance manager component 202 generates one or more filter(s) 228 for further refining the search result(s) 208. In this example, the filter(s) 228 are presented to the user with the initial search result(s) 208 via a user interface on the user device 216, such as, but not limited to, the UI device 120 in FIG. 1. If the user selects one or more of the filter(s), the query 210 is automatically updated to include the filtered terms and/or a new query is generated that includes the selected filter(s). In response to the selected filter(s), updated search results are obtained from the search engine 206 that is further refined. The refined search results include items which are more closely related to the user's intended purpose and/or more likely to include items needed or wanted by the user. In this example, the AR images are described as augmented reality images. However, in other examples, the AR images are AI generated images rather than AR images. In other words, the entire image may be rendered by AI rather than combining real world image elements to create an AR image.

In some examples, the user device accesses/performs a search for items available via an online catalog of items and/or services associated with a guided shopping experience webpage 232 hosted on a webserver 234. The webserver 234 is accessible via an API. The catalog 240 includes item data 242 associated with products and/or services. The item data 242 includes various item attributes such as item names, size/quantity information, location in store, pricing, variety, brand, as well as any other type of item information. In other examples, the item data include relevancy information of connected items and services, inventory information, supply chain/speed of service information, rating, reviews (various sources), advertising platform (sponsors), offers engine, etc.

The catalog 240 in some examples also includes promotions data 244 associated with offers 246, such as discounts, specials, rebates, coupons, or other deals.

The catalog 240 optionally also includes sponsored item(s) 248. Sponsored item(s) 248 are items which are being sponsored on the guided shopping experience webpage 232 for a given period of time. During the sponsorship time period, the sponsored items are given preferential placement on webpage displays, search results, and other item information pages, improving visibility of the sponsored items.

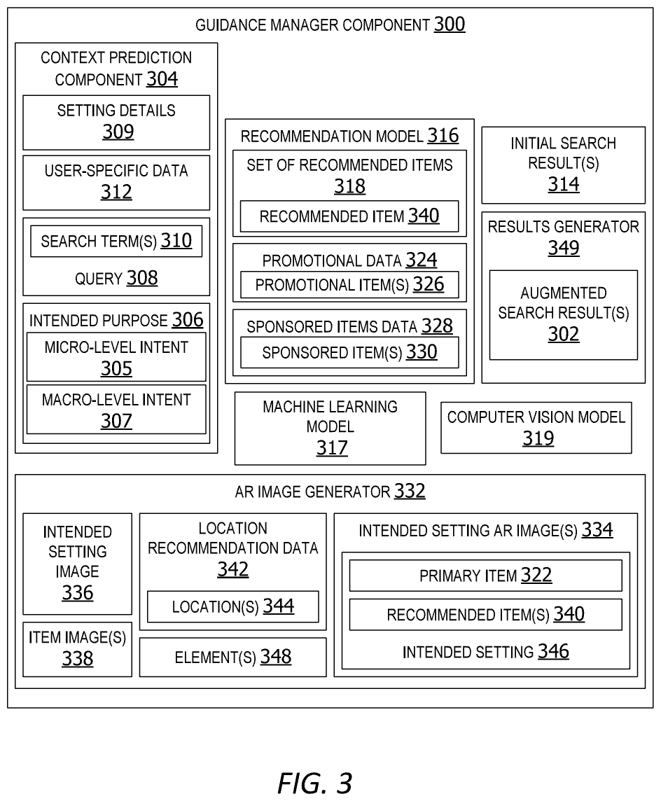

Turning now to FIG. 3, an exemplary block diagram illustrating a guidance manager component 300 for generating augmented search results 302 for intent-based shopping guidance is shown. The guidance manager component 300 is a component for generating augmented search results for use in enhancing a user's shopping experience, such as, but not limited to, the guidance manager 130 in FIG. 1 and/or the guidance manager component 202 in FIG. 2.

In some examples, a context prediction component 304 generates a personalized prediction of a user's intended purpose 306 based on query 308 search term(s) 310, setting details 309, item attributes such as from item data 242, and/or user-specific data 312. The query 308 is a search query such as, but not limited to, the query 124 in FIG. 1 and/or the query 210 in FIG. 2. The search query includes one or more search term(s) 310, such as, but not limited to, the search term(s) 122 in FIG. 1 and/or the search term(s) 212 in FIG. 2.

Setting details 309 can be details of a depicted setting of an image provided to guidance manager component 300 from the user along with or as part of query 308. Context prediction component 304 can utilize a computer vision (CV) model 319 in identifying setting details 309 from the setting depicted in the image.

In some examples, the intended purpose 306 includes determining multiple levels of intent. As shown, intended purpose 306 can include a micro-level intent 305 and a macro-level intent 307. Micro-level intent 305 can relate to a narrow or specific reasoning for the query 308 and/or the primary item 322, where the macro-level intent 307 can relate to a broader reasoning query 308 and/or the primary item 322. As an illustrative example, if from a query 308, guidance manager component 300 identifies a television as a primary item 322, context prediction component 304 may identify the micro-level intent 305 as being related to building a media center, where the macro-level intent 307 may be identified as buying new furniture for a new home.

In some examples, context prediction component 304 utilizes a machine learning (ML) model 317 in identifying intended purpose 306, micro-level intent 305, and macro-level intent 307. ML model 317 can be trained using various training data, such as user-specific data 312, item attributes such as item data 242, data stored by catalog 240, and setting details 309, for example, to ultimately identify micro-level intent 305, macro-level intent 307, and intended purpose 306 for an associated query 308 and/or primary item 322.

In some examples, the guidance manager component 300 obtains initial search results 314 generated by a search engine in response to the initial query 308. In some examples, a recommendation model 316 analyzes a plurality of items and/or services available in a products catalog to identify a set of recommended items 318. The products catalog is a catalog or database of item information associated with one or more items and/or services available for order or purchase from a retailer, such as, but not limited to, the catalog 240 in FIG. 2.

The set of recommended items 318 is a set of one or more complementary items predicted to be needed or wanted by a user in conjunction with a primary item 322. The primary item 322 is the object of the search query 308, such as, but not limited to, the primary item 142 in FIG. 1. A recommended item 340 in the set of recommended items 318 can include a physical item (product) or a service, such as a streaming service, installation service, delivery service, etc.

In some embodiments, the recommendation model 316 analyzes promotional data 324 describing one or more promotional item(s) 326 in the plurality of available items to identify any promotional items for inclusion in the set of recommended items 318 recommended to the user in additional to the primary item 322. A promotional item is an item associated with a discount, offer, rebate, sale price, coupon, or other promotional deal.

In other embodiments, the recommendation model 316 analyzes sponsored items data 328 describing one or more sponsored item(s) 330 in the plurality of available items in the catalog for inclusion in the set of recommended items. A sponsored item is an item which is being sponsored or otherwise promoted for a specific time-period.

The recommendation model 316 in some examples includes a ML model for analyzing item data and identifying items likely to be needed or wanted by a user based on the user-specific data, such as purchase history, and the intended purpose 306 of the query 308. In other words, the ML model analyzes the item data and user-specific data with the intended purpose associated with a JTBD to identify recommended items, such as promotional items and/or sponsored items, which are likely to be assist the user in performing the JTBD and likely to be of interest to the user based on the user's historical purchases and known preferences.

In other embodiments, an AR image generator 332 is a component that generates intended setting AR image(s) 334 based on an intended setting image 336 of an environment in which the primary item is to be used and item image(s) 338 of the primary item 322 and the additional recommended item(s) 340. The AR image generator 332 optionally obtains item image(s) 338 from the item data in the catalog and/or the images can be obtained from one or more databases or other online sources via a network connection.

The AR image generator 332 in some embodiments generates location recommendation data 342 recommending one or more location(s) 344 for each item in the set of recommended items 318 and/or the primary item 322 within the intended setting 346. The recommended location is generated based on the dimensions of the intended setting (room size), lighting, location of doors and windows, locations of fixtures, locations of furniture, dimension of the primary item, dimensions of the recommended item(s), etc.

The AR image generator 332 generates the intended setting AR image(s) 334 using one or more element(s) 348 extracted from the user-provided intended setting image 336 and/or the item image(s) 338. These elements includes real-world elements, such as walls, windows, floors, ceilings, and fixtures located within the intended setting. The element(s) 348 also include virtual elements, such as AI or AR created images of the primary item, one or more recommended items, and/or one or more user images provided by the user. The element(s) 348 are combined together to create an intended setting AR image of the intended setting 346 including the primary item 322 as well as one or more recommended item(s) 340 being recommended to the user for purchase within the augmented search result(s) 302.

A results generator 349 generates the augmented search result(s) 302 for presentation to the user via one or more search results pages. The augmented search result(s) 302 include item information for the primary item as well as one or more recommended items. The augmented search result(s) 302 optionally also includes one or more intended setting AR image(s) 334.

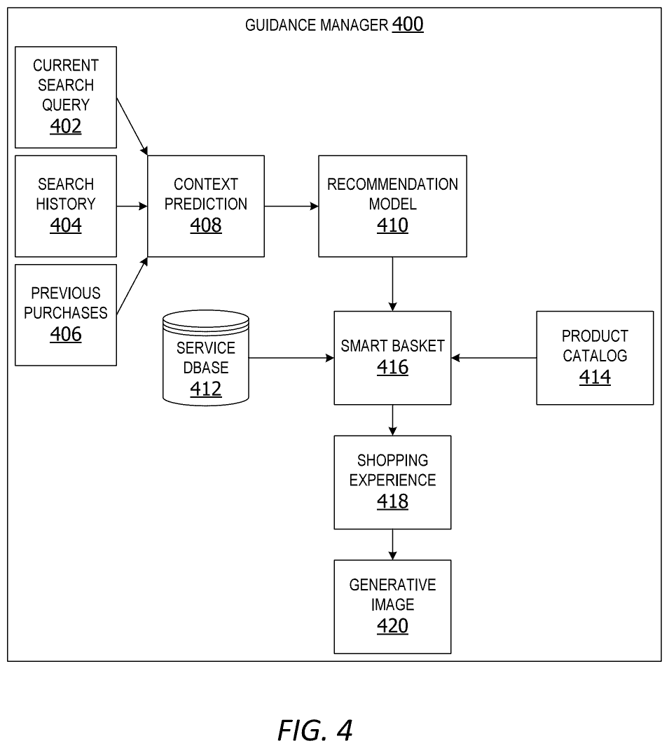

FIG. 4 is an exemplary block diagram illustrating a guidance manager 400 component workflow. The guidance manager 400 receives input, including the current search query 402, search history 404, and/or previous purchases 406. The current search query 402 is a search query including one or more search terms for retrieving items that are the same as or similar to a desired primary item, such as, but not limited to, the query 124 in FIG. 1, the query 210 in FIG. 2, and/or the query 308 in FIG. 3. The search history 404 includes data associated with previous search queries, such as, but not limited to, the search history 156 in FIG. 1 and/or the user-specific data 312 in FIG. 3. The previous purchases 406 is data describing one or more items and/or services previously purchased by the user, such as, but not limited to, the purchase history 154 in FIG. 1 and/or the user-specific data 312 in FIG. 3.

A context prediction 408 analyzes the inputs to identify an intended purpose of the current search query 402. The context prediction is a component for identifying a job to be done and/or the intended purpose of the search or primary item the user is considering for purchase, such as, but not limited to, the context prediction component 304 in FIG. 3. In this example, the context prediction 408 includes a generative AI ML model.

A recommendation model 410 uses the predicted intended purpose to identify items from a service database 412 and/or a product catalog 414 for recommendation to the user. The service database 412 is a database or catalog of services available from one or more service providers available for purchase subscription. The services are selected based on the intended purpose and the user-specific data. The user-specific data can include product reviews by the user as well as product reviews by other users. The user-specific data can also include any preference data provided by the user associated with the user's preferences (likes and dislikes).

The product catalog 414 is a database or catalog of physical items/products available for sale or purchase by the user, such as, but not limited to, the catalog 240 in FIG. 2. The additional recommended items selected from the service database 412 and/or the product catalog 414 are presented to the user via a guided shopping experience 418 UI or webpage. The recommended items (recommended items) are viewable via a smart basket 416. The smart basket 416 includes the additional recommended items with additional item data, such as pricing information, discounts/offers, images of the items, as well as any other relevant information. A generative image 420 of the recommended items are shown in an image, such as, but not limited to, the intended setting AR image 136 in FIG. 1, the AR image(s) 220, and/or the intended setting image 336.

FIG. 5 is an exemplary flow chart illustrating operation of the computing device to generate augmented search results for use in providing enhanced shopping guidance to customers. The process 500 shown in FIG. 5 is performed by a guidance manager component, executing on a computing device, such as the computing device 102 or the user device 116 in FIG. 1.

The process begins by obtaining search results associated with a query at 502. The search results are generated by a search engine, such as, but not limited to, the search engine 126 in FIG. 1 and/or the search engine 206 in FIG. 2. A primary item is identified at 504. The primary item is identified from a plurality of available items using the search terms as well as any available user-specific data indicating user preferences and purchasing trends. The intended purpose of the primary item is identified at 506. In some examples, the intended purpose is predicted by a personalized context prediction component, such as, but not limited to, the context prediction component 304 in FIG. 3 and/or the context prediction 408 in FIG. 4.

A set of recommended items is generated for the primary item and intended purpose at 508. An image of an intended setting for use of the primary item and/or the recommended items is requested at 510. In this example, the request is sent to a user device, such as, but not limited to, the user device 116 in FIG. 1 and/or the user device 216 in FIG. 2. A determination is made whether the image is received at 512. If not, the augmented search results are generated at 516. The results do not include an AR image showing planned use of the primary item. The results are presented to the user with shopping guidance at 518. The process terminates thereafter.

If an image of an intended setting is received from the user device and/or obtained from a data storage device, the guidance manager generates an intended setting AR image at 514. The intended setting AR image is an AI generated or AR image showing the primary item with one or more recommended items being used within the intended setting. The augmented search results are generated at 516. The search results include the intended setting AR image. The results are presented to the user with the shopping guidance at 518. The process terminates thereafter.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

FIG. 6 is an exemplary flow chart illustrating operation of the computing device to generate intent-based filter suggestions for use in refining search results for an improved shopping experience. The process 600 shown in FIG. 6 is performed by a guidance manager component, executing on a computing device, such as the computing device 102 or the user device 116 in FIG. 1.

The process begins by obtaining search results at 602. The search results are results generated by a search engine in response to a search query, such as, but not limited to, the search engine 126 in FIG. 1 and/or the search engine 206 in FIG. 2. Suggested search filters are generated at 604. The filters are focused search terms, such as, but not limited to, the filter(s) 146 in FIG. 1 and/or the filter(s) 228 in FIG. 2. A determination is made whether a user selects a suggested search filter at 606. If not, the process determines whether to continue at 612. If yes, the process iteratively executes operations 602 through 612 until a determination is made not to continue. The process terminates thereafter.

If a filter is selected at 606, a refined search query including the selected filter(s) is generated at 608. The filters are selected by a user using a UI device, such as, but not limited to, the user interface device 110 and/or the UI device 120 in FIG. 1. The filter selections are received by the guidance manager component via a network, such as, but not limited to, the network 112 in FIG. 1. The refined search query is submitted to the search engine at 610. A determination is made whether to continue refining the search results at 612. If yes, the process iteratively executes operations 602 through 612 until a determination is made not to continue refining the search results. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

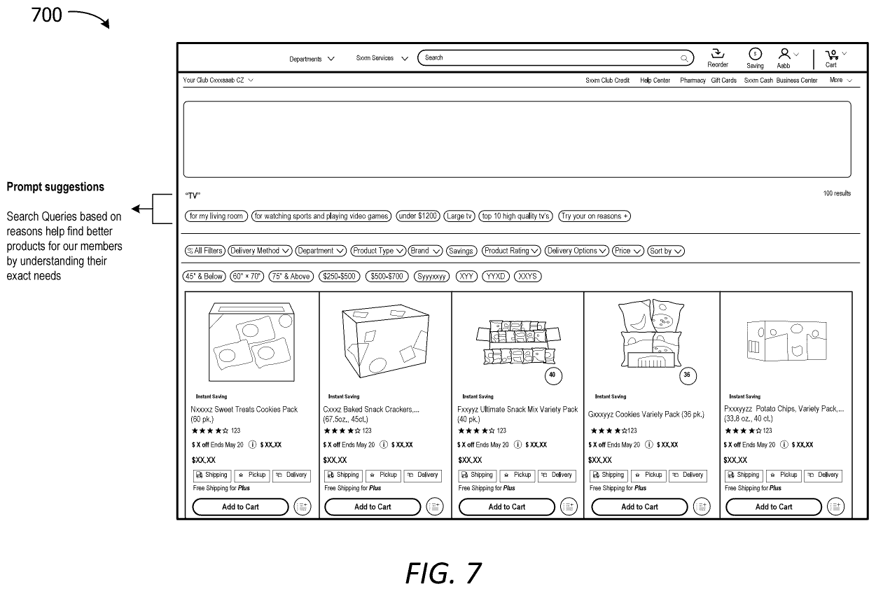

Referring now to FIG. 7, an exemplary screenshot 700 illustrating a guided shopping page having prompt suggestions for filtering a search query into a more refined search query is shown. The prompt suggestions include one or more prompts encouraging the user to select a recommended filter search term to refine the search results. Search queries based on reasons help find better products (items) for customers by understanding their exact needs.

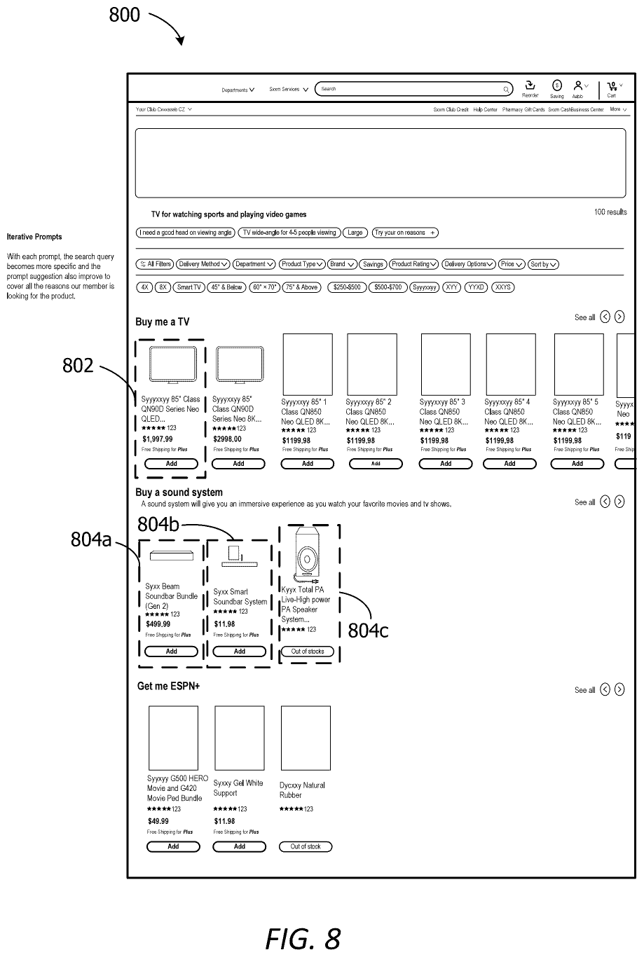

FIG. 8 is an exemplary screenshot 800 illustrating a guided shopping page having iterative filtering suggestions for further refining a search query. In this example, iterative prompts are presented to the user prompting the user to select narrowing/refined search terms for enabling provision of more refined search results. With each prompt, the search query becomes more specific, and the prompt suggestions also improve to cover all the reasons the customer is looking for the primary item. Icon 802 may be a selectable icon for selecting a primary item and icons 804a, 804b, 804c may be selectable icons for selecting recommended items.

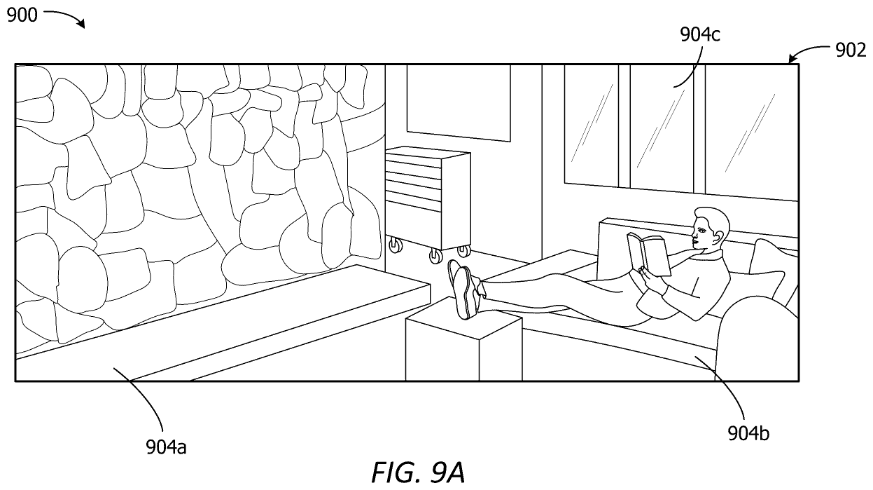

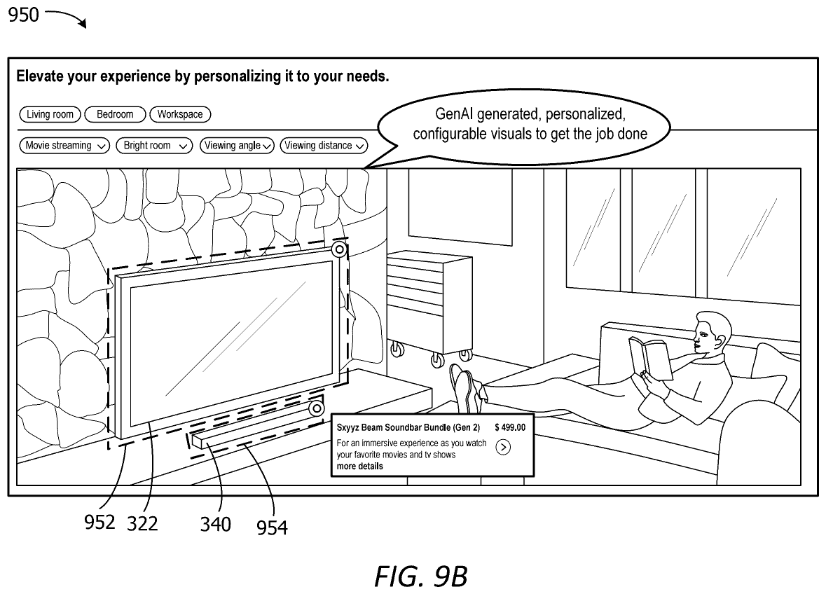

FIG. 9A illustrates an example image 900, substantially similar to images 224 and/or intended setting images 336 previously discussed. In some embodiments, image 900 is provided by a user from user device 216 to guidance manager component 300, as previously discussed. As shown, image 900 depicts a setting 902. As shown, in this illustrative example, the setting 902 is the user's living room. CV model 319 can process image 900 to determine various setting details 904 related to setting 902, substantially similar to setting details 309 previously discussed. For example, as shown, CV model 319 identifies that setting 902 includes a TV stand (as illustrated by detail 904a), a sofa (as illustrated by detail 904b), and a wall of windows behind the sofa (as illustrated by detail 904c). Those with skill in the art will recognize that details 904a-904c are illustrative example details identifiable by CV model 319 from setting 902, and that CV model 319 can be trained to identify any of various setting details 904 associated with setting 902, such as room size, room type, room location, room lighting, and the like, for example. Further, while setting 902 depicts a room, various settings can be identified and processed by CV model 319, such as outdoor areas, retail areas, vehicle interiors/exteriors, fashion-related settings, closest, warehouses, garages, school rooms, attics, basements, and the like, for example, and associated setting details can be detected or identified by the CV model 319 for each of the settings.

FIG. 9B illustrates an example modified image 950, substantially similar to images 334 previously discussed. In some embodiments, AR image generator 332 generates modified image 950 to include primary item 322 and recommended items 340. In this illustrative embodiment, a television is illustrated as primary item 322 and a sound bar is illustrated as a recommended item 340. As shown, AR image generator 332 determines a primary location 952 and relative size for primary item 322, such as by using setting details 904 and/or item attributes from item data 242, for example. As shown, AR image generator 332 determines that the primary location 952 for the television primary item 322 is on top of the TV stand. AR image generator 332 determines a recommended location 954 for recommended item 340 using various setting details 904, item attributes from item data 242, and/or the location of the primary location 952. As shown, AR image generator 332 determines that the recommended location 954 for the sound bar recommended item 340 is on the TV stand in front of the television.

In some examples, AR image generator 332 generates modified image 950 based on detected interface selections made by the user. For example, as previously discussed, guidance manager component 300 can present selectable icons 802, 804 for selection by a user. Upon detecting the selection of icons 802, 804 made by a user on user device 216, AR image generator 332 identifies a corresponding primary location 952 or recommended location 954 corresponding to the item depicted in the selected icon 802, 804 and adds the item to the modified image 950 accordingly.

In these examples, the augmented search results are generated in response to a search query submitted to a search engine associated with an online shopping webpage or application. However, the embodiments are not limited to online shopping. In other examples, the guidance manager can analyze an image of an item. The item image can be an image obtained from a database or other data storage device, as well as an image obtained from an online source. In other examples, the image is an image of an item generated by a user operating an image capture device to capture an image of an item that is located within a brick and mortar store or an item otherwise in possession of the user operating the image capture device.

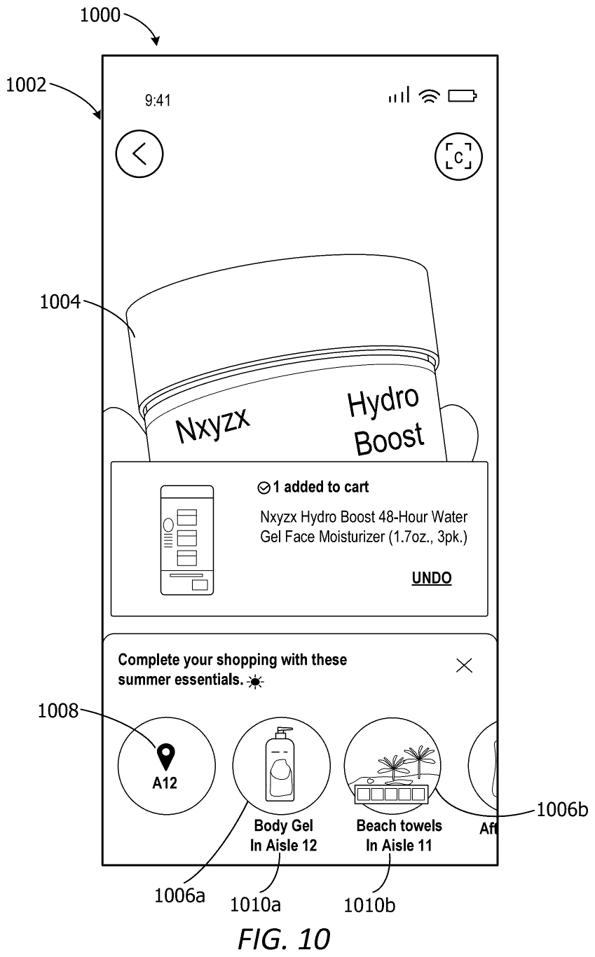

Referring now to FIG. 10, an exemplary screenshot 1000 illustrating recommended items with location information for the recommended item shown. In this example, an image capture device captures an image 1002 of a primary item 1004. The image capture device is any type of camera or other device for generating images, such as, but not limited to, the image capture device 222 in FIG. 2. The guidance manager component uses the image data to identify a primary item 1004, such as by using CV model 319, or by interpreting a barcode of the item, for example. The guidance manager component 300 then generates a set of recommended items 1006a, 1006b to be used in conjunction with the primary item 1004. In this example, the recommended items 1006a, 1006b are presented below an image of the primary item and an item description box containing item data associated with the primary item.

In some examples, the recommended items 1006 are recommended at least partially based on their location or proximity to the primary item 1004. For example, in the illustrated embodiment, the user captures image 1002 while in a retail facility as part of a “scan-and-go” feature where the user can add items to a virtual shopping cart. Guidance manager component 300 can determine the user's location 1008 in a retail facility, such as by geographic data 166, location data from user device 216, and/or location data associated with primary item 1004 in the store taken from item data 242. Guidance manager component 300 can select recommended items 1006 based at least partially on their proximity to the user's location 1008. For example, guidance manager component 300 can determine locations 1010 for each of the recommended items 1006 within a retail facility (such as aisle locations, for example) from item data 242, and select recommended items 1006 based on their proximity to the user's location 1008. As shown in this illustrative example, the user location 1008 is “Aisle 12”, the location 1010a of recommended items 1006a is also “Aisle 12”, and the location 1010b of 1006b is “Aisle 11”.

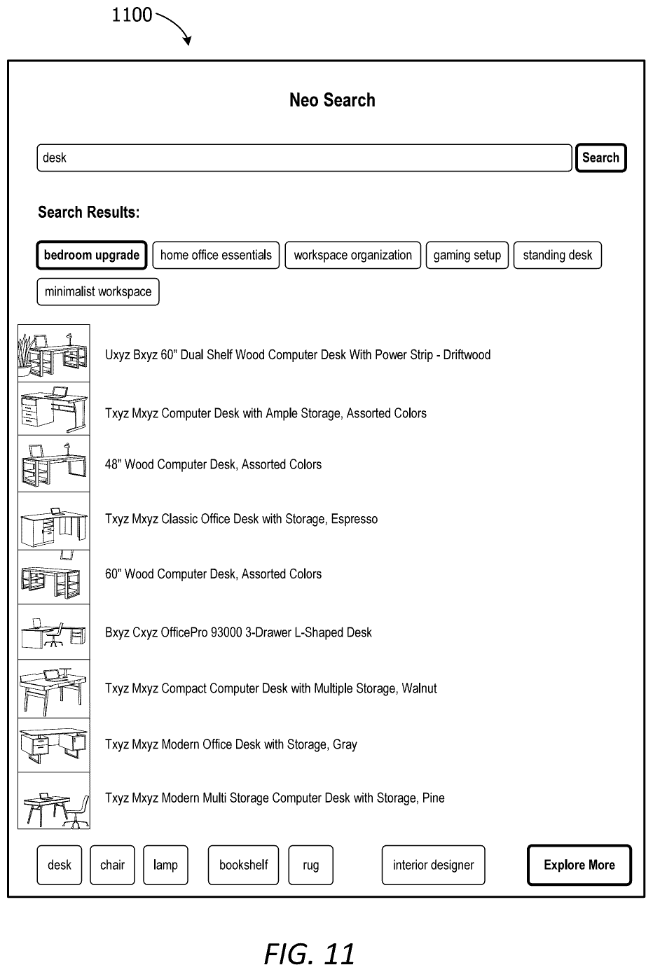

FIG. 11 is an exemplary screenshot 1100 illustrating initial search results with recommended filters for refining the search results based on intended purpose of the primary item. In this example, a query for a “desk” corresponds to search results for a variety of desks, as shown in FIG. 11. The user is prompted to select a filter (additional refining search terms) to further refine the search results. In this example, the “bedroom upgrade” suggested filter is selected. The search term “desk” and the additional filter “bedroom upgrade” is used to further refine the search results as well as predicting the intended purpose of the primary item, a desk. In this example, the job to be done is an upgrade of a bedroom. The intended purpose of the desk is to be used in a bedroom as part of the upgrade.

In this example, the guidance manager provides a set of recommended items to be purchased in conjunction with the desk. The recommended items include a bookshelf, rug, lamp, chair, etc.

In other examples, the guidance manager provides recommendations based on items in a customer's basket and/or items scanned by the customer. The items can be scanned as the user shops in a brick and mortar retail facility. In other examples, the recommendations are generated based on one or more items placed into a customer basket during online shopping via a webpage or application.

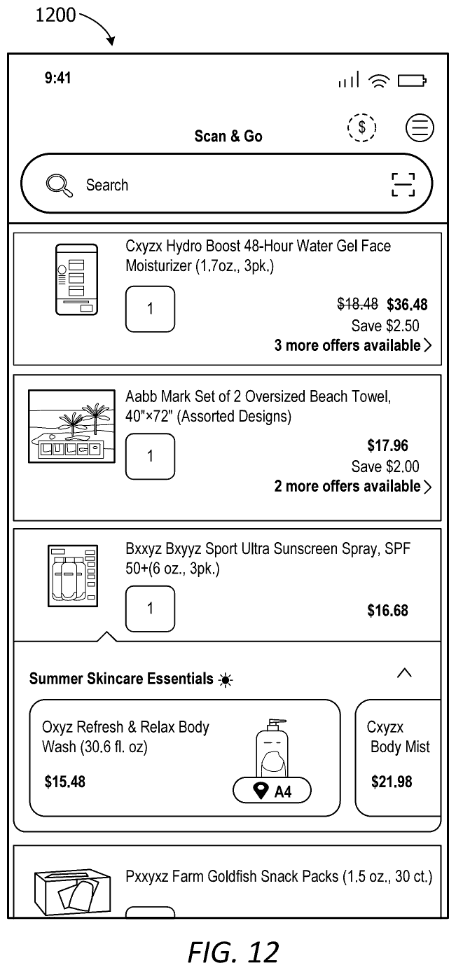

FIG. 12 is an exemplary screenshot 1200 illustrating recommended items consistent with a predicted intended purpose of one or more items in a customer basket. In this example, there are three items within a basket. Based on the items within the basket, the system provides recommended items, such as body wash and other items frequently used in conjunction with one or more of the items in the basket.

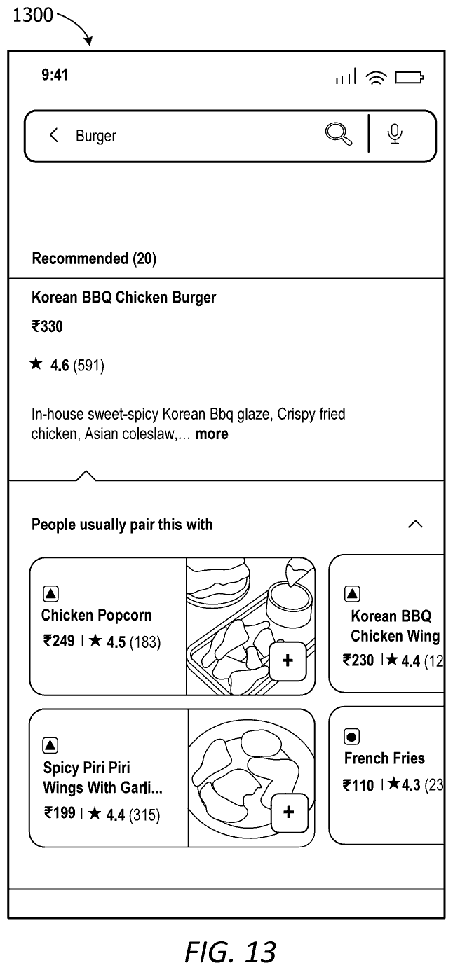

FIG. 13 is an exemplary screenshot 1300 illustrating recommended items consistent with a predicted intended purpose of a primary item being viewed on a search results page. In this example, recommendations are based on a selected food item. The system identifies other food items which are typically served or consumed with the selected food item.

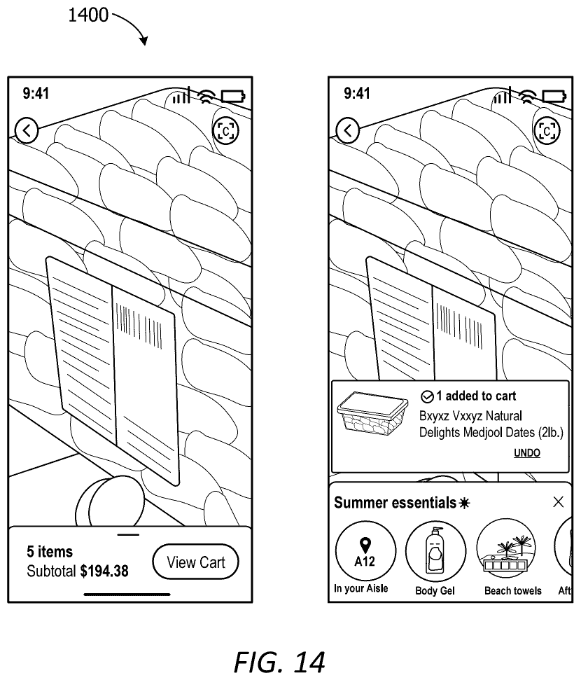

FIG. 14 is an exemplary screenshot 1400 illustrating additional recommended items consistent with a predicted intended purpose of one or more items scanned by a customer via a shopping application. In this example, an item is scanned, or an image is taken of the item. The guidance manager uses the image data and/or scan data of the item to identify one or more items which are located near the primary item. In this example, the primary item includes a package of dates. The system identifies one or more recommended items including items which the user may want or need which are located near the primary item. This assists the user in obtaining desired items while minimizing the amount of time spent walking around a brick and mortar store.

Upon detecting an application on a user device invoked from within a brick-and-mortar store, the search transforms into an in-store search experience. A scan to search on the search bar can trigger a scan and go (Scan & Go) experience to help provide easy entry point. The scan and go function enables the user to scan the barcode or other product identifier (ID) on a product to automatically add that item into the user's digital cart within the application. The user can scan each item the user wishes to purchase. When finished, the user can pay for all items in the cart and complete checkout using the application without going through a staffed checkout or traditional self-check-out (SCO) terminal. The JTBD framework helps boost sales/purchases of personalized complimentary products and services.

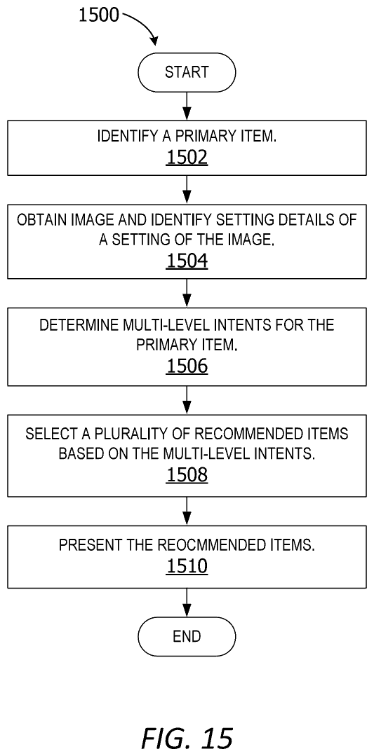

FIG. 15 is a flowchart illustrating a method identifying and presenting recommended items using multi-level intended purposes. Method 1500 can begin at block 1502 by identifying a primary item from query 308, such as primary item 322 and primary item 1004 previously discussed, for example. Method 1500 can continue to block 1504 by obtaining an image and identifying setting details from the image, such as image 900 and image 1002 previously discussed, for example, and determining setting details from the images, such as details 309 and details 904 for example.

Method 1500 can continue to block 1506 by determining multiple levels of an intended purpose 306, such as micro-level intent 305 and macro-level intent 307, for example. Method 1500 can continue to block 1508 by selecting a plurality of recommended items, such as recommended items 340 and recommended items 1006, based on the multiple levels of intent.

In performing block 1506, guidance manager component 300 can utilize ML model 317 in selecting recommended items associated with micro-level intent 305 and macro-level intent 307. For example, ML model 317 can generate recommended items 340 associated with micro-level intent 305 that belong to a same or similar item-type as the item-type of primary item 322, and can generate recommended items 340 associated with macro-level intent 307 that belong to a different item-type than the item-type of primary item 322.

For example, the primary item 322 can be a television, and context prediction component 304 and ML model 317 can identify from setting details 309, user-specific data 312, search term(s) 310, and/or query 308 that the user's micro-level intent 305 is to complete a media center, and can suggest recommended items 340 associated with that micro-level intent 305 also associated with media center item-types, such as speakers, sound bars, video game counsels, and the like. Keeping with the example where the primary item 322 is a television, the context prediction component 304 and ML model 317 can identify from setting details 309, user-specific data 312, search term(s) 310, and/or query 308 that the user's macro-level intent 307 is related to buying new items for moving into a new house, and can suggest recommended items 340 associated with that macro-level intent 307 having item-types outside of media center item-types associated with the primary item 322, such as carpets, kitchen appliances, bedding, curtains, and other items needed when moving into a new home. Method 1500 can continue to block 1510 where recommended items 340 are presented to the user via user device 216, such as by selectable icons 804.

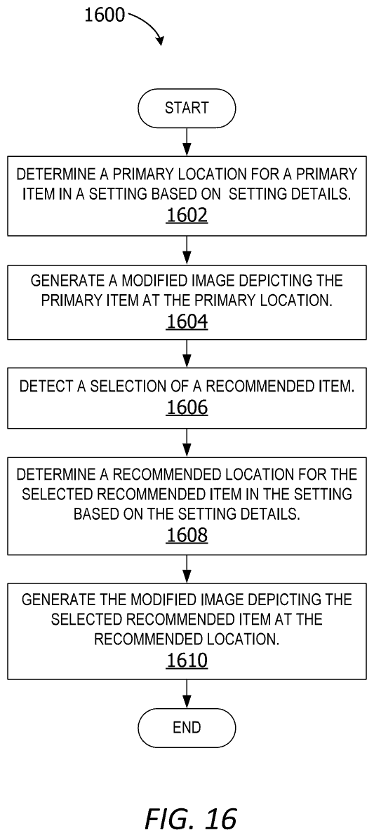

FIG. 16 is a flowchart illustrating a method for generating a modified image including primary items and recommended items. In some embodiments, method 1600 is applied in conjunction with other methods discussed herein such as method 1500, for example. Method 1600 can begin at block 1602 by determining, within a setting 902, a primary location 952 for primary item 322 Primary location 952 can be determined based on various setting details 904 and item attribute associated with primary item 322, such as from item data 242, for example. In some embodiments, block 1502 is performed responsive to detecting selections of a primary item, such as selection of icon 802, for example. Method 1600 can continue to block 1604 by generating modified image 950 to include primary item 322 at the primary location 952.

Method 1600 can continue to block 1606 by detecting a selection of one of the recommended items 340, such as a user selection of one of selectable icons 804, for example. Method 1600 can continue to block 1608 determining a recommended location 954 in setting 902 for the recommended item 340. Recommended location 954 can be determined based on various setting details 904 and item attribute associated with the recommended item 340, such as from item data 242. Method 1600 can continue to block 1610 by generating modified image 950 to include the selected recommended item 340 depicted at the recommended location 954.

### Additional Examples

In some examples, the system integrates generative AI into a product search to allow for guided retail shopping experiences based on user intent. The system combines search results with generative AI to provide a more natural language shopping experience for users. The system interprets a user query (entry) using the generative AI, user profile, purchase and shopping history, and other user-specific data to focus the results initially. The system displays recommended product listing pages and a list of appropriate recommended filters to allow the user to focus on results on items and/or services most likely to be desirable by the user. The system indicates the items (products) which were the results of the search, and the complimentary items associated with the primary item. The generative AI develops an AR image of the selected item and it's complimentary items (products) in the user selected setting where the user specified their use.

In an example, the system obtains inputs from a query, uses the inputs to create an understanding of what the user (customer/shopper) needs and/or wants, and adds value by predicting the intended purpose of the primary item, predicting the JTBD, predicting complementary items related to the JTBD, predicting the most relevant offers, deals and sponsored items. The system generates an AR image showing a primary item (selected item) and recommended (associated) items in a user setting/environment associated with the intended use/purpose of the primary item. In some examples, the AR image includes a real world environment populated with items and/or services added at appropriate locations within the image to demonstrate the intended use/simulating the intended use of the primary item. The system shows the most relevant items in search results, associated items that the user is likely to need (predictive), offers and deals associated with the items, and/or sponsored items that are most relevant to the predicted intended use/need/want of the user.

In some examples, the system uses generative Alto interact with the user during the shopping process to gain the inputs and interpret what the user is looking for, and for what context (how the user intends to use the product/item/service) to provide more relevant results filtered/focused in a way that improves the customer experience. The system utilizes augmented reality (AR) or AI to generate a visual of the relevant products in the user's intended setting (i.e., the user's living room, for a TV search). This enables guided retail shopping experiences.

In other examples, the system combines search with generative AI to provide a more natural and intuitive shopping experience for users. The system interprets the user's natural language search terms and queries with user-specific data to generate augmented search results during a guided shopping experience. In an example, the system receives search terms and results of a search from a search engine. The system analyzes user-specific data (user history, profile, purchases, etc.) and identifies the intended use of the primary item. The system focuses the search results and suggests filters to further focus the results. The system predicts complementary/additional products and/or services that are likely to be used in conjunction with the primary item and/or in furtherance of the JTBD.

The system, in some examples, obtains a real world image of user selected setting for use of the selected item. The system generates AR images of the user selected setting enhanced with images of the selected item and complementary items/recommended items located at appropriate places within the image of the user selected setting, The AR image includes real world elements and AR/virtual elements. The AR image is provided to the user to assist the user with deciding whether to purchase the primary item and/or the recommended items.

A JTBD can include any type of event, such as sports, games, parties, holidays, block party, work meeting, etc. A query stating, “help me find a tv for streaming in a well-lit room,” in some examples, results in recommendations for complementary items, such as wall brackets, cables, and other items which may be needed to set up the television for use.

In other examples, the system includes a method to integrate generative AI into the search to allow for guided retail shopping experiences. A search engine and generative AI model exchange data (communicate back and forth). The search results are provided to the generative AI, filters from the generative AI are provided back to the search engine, etc. The method displays most relevant items in the search results. The method predicts/shows items associated with the search result (including items that the user might need). The method shows offers and deals associated with the items. The method shows sponsored items that are most relevant to the predicted need/want of the user. The method uses generative AI to interact with the user during the shopping process to gain the inputs (interactive prompts). The method interprets the need of the user to provide most relevant results to improve customer experience. The method uses AR or AI to generate a visual of the relevant products in the user's intended setting (i.e., the user's living room, for a TV search) Image shows recommended items in an intended setting.

In other examples, the system identifies jobs to be done, which provides more contextual basket building for customers as opposed to systems providing numerous recommendation carousels sprinkled across many pages and touch points during the shopping experience, which can be frustrating and annoying for users. The covered jobs are key events, occasions, activities, interests, and lifestyle goals. The purchases of individual products are part of a bigger picture to address specific micro jobs and macro jobs that the customer is trying to get done. In an example of a micro job the customer searches for a television because the user is interested in streaming and binge watching television shows and movies provided by one or more streaming providers. In this example, the purpose of the television is streaming television shows and movies. The JTBD is setting up a system that enables the user to stream content from a streaming services provider. In order to accomplish the macro job of streaming content from a service provider, other related items may be required, such as a sound bar, cables, a streaming device, a sofa or chair, etc.

In some examples, the system provides augmented search results enabling the user to pivot quickly with an easy way to add or switch choices. The provided shopping experience is visually rich, easy to comprehend and easy to use.

Generative AI marries the users' information to the items and services information, to serve in many ways the needed items or services. Search queries based on jobs assist the user in finding better products for our users by understanding their exact JTBD. The prompt suggestions are generated based on intent (reasons) to help find better products for customers by understanding their exact needs. With each prompt, the search query becomes more specific, and the prompt suggestions also improve to cover all the key Jobs our member is trying to get done by hiring specific product. The AR images enable the user to visualize the future state of life with the products or services with generative AI.

The system learns a user's preferences and needs based on the items and services the user chooses. The recommended filters help further refine recommendations for the intended setting, such as the room size, occasion, placement, and complementary products and services. The AI offers tagged items in the imagery/video. It can also offer services, such as installation and setup services. The AI can also pull the most relevant sponsored items and services to offer the user. The AI can pull the most relevant deals, especially if price is an indicator for the user.

The system learns the user's (customers) needs based on the items viewed, selected and/or purchased by the user. If there are other options that would work, the AI can allow the user to switch the primary item, that refreshes the related items, that would be needed. In other words, if the user selects a new primary item, the system updates the recommended items accordingly.

In still other examples, the system provides the ability for a user to get a JTBD (occasion, events, placement context, complimentary category/subcategory data) from generative AI for given products/services. Personalized generative experience integrates the current search context and the member's historical context to build and present in real-time to the PLP and PDP. The generative AI identifies the JBTD given the current search and personalized context, determines what JBTDs are relevant given the context, determines what products and services are available for a user to consider, and how the items and services can be presented to the user by interacting with the member's search experience. In other examples, the system also uses information about the intended setting, such as room size, viewing distance, angle, room lighting, etc.

The recommended (complementary) items (products and services) for a given primary item are separated out by various product/services categories, for example, audio equipment, connected accessories, streaming devices, gaming equipment. Personalized complimentary products/services for a given product, for a given occasion and placement context combination. For example, the user may want to binge watch television shows and movies in a bright, large room. The results are presented for viewing by the user via the augmented shopping experience.

Using JTBD framework to extend the conversational and visual user interface (UX) to other touch points like search typehead, cart (visual cart), checkout, buying guides, and product finders.

Various examples herein include identifying a primary item from an initial query received from a user interface (UI) device and item attributes associated with the primary item; obtaining an image from the UI device and identify setting details associated with a setting depicted in the image using a CV model; determining, using a ML model based at least on the item attributes and the setting details, a micro-level intent for the primary item and a macro-level intent for the primary item; selecting, using the ML model, a plurality of recommended items for use in conjunction with the primary item, wherein the plurality of recommended items includes at least one micro-item belonging to a same or similar item-type as the primary item selected based on the micro-level intent and at least one macro-item belonging to an item-type outside of the item-type of the primary item selected based on the macro-level intent; and presenting each of the plurality of recommended items via the UI device as a selectable option for including in a selection experience including the primary item.

Alternatively, or in addition to the other examples described herein, examples include any combination of the following:
determining a primary item location for the primary item in the setting based on the setting details; and generating a modified image depicting the primary item at the primary item location of setting and present the modified image via the UI device.
detecting a selection of a selectable option corresponding to one recommended item of the plurality of recommended items; determining a recommended item location for the one recommended item based on the setting details; and generating the modified image to include the one recommended item at the recommended item location of the setting.
wherein the modified image is presented as an augment reality (AR) image.
wherein the initial query includes the image and the primary item is identified from the image using the CV model.
identifying a location where the image was captured; and selecting the plurality of recommended items based at least on the location.
presenting, via the UI device, a primary location corresponding to a location of the primary item relative to the location where the image was captured; and for each of the plurality of recommended items, presenting, via the UI device, a recommended location corresponding to a location of the recommended item relative to the location where the image was captured.

At least a portion of the functionality of the various elements in FIG. 1, FIG. 2, FIG. 3 and FIG. 4 can be performed by other elements in FIG. 1, FIG. 2, FIG. 3 and FIG. 4, or an entity (e.g., processor 106, web service, server, application program, computing device, etc.) not shown in FIG. 1, FIG. 2, FIG. 3 and FIG. 4.

In some examples, the operations illustrated in FIG. 5, FIG. 6, FIG. 15, and FIG. 16 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of intent-based augmented shopping guidance, the method comprising obtaining initial search results generated by a search engine, the initial search results associated with an initial query received from a user interface (UI) device; identifying a primary item from the initial search results and an intended purpose associated with the primary item using the initial query and the initial search results; generating a set of associated items corresponding to the primary item and the intended purpose of the primary item using user-specific historical data and user-specific profile data, the set of associated items comprising at least one item or service to be used in conjunction with the primary item; creating an intended setting augmented reality (AR) image comprising a visual representation of the primary item and the set of associated items being used for their intended purpose within the intended setting; and generating augmented search results responsive to the initial query, wherein the augmented search results include the primary item, the set of associated items, and the intended setting AR image of the primary item with the set of associated items within the intended setting for use of the primary item, wherein the augmented search results are presented to the user via the UI device.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for intent-based augmented shopping guidance. For example, the elements illustrated in FIG. 1, FIG. 2, FIG. 3, and FIG. 4, such as when encoded to perform the operations illustrated in FIG. 5 and FIG. 6, constitute exemplary means for obtaining initial search results generated by a search engine, the initial search results associated with an initial query received from a user interface (UI) device; exemplary means for identifying a primary item from the initial search results and an intended purpose associated with the primary item using the initial query and the initial search results; exemplary means for generating a set of associated items corresponding to the primary item and the intended purpose of the primary item using user-specific historical data and user-specific profile data, the set of associated items comprising at least one item or service to be used in conjunction with the primary item; exemplary means for creating an intended setting augmented reality (AR) image comprising a visual representation of the primary item and the set of associated items being used for their intended purpose within the intended setting; and exemplary means for generating augmented search results responsive to the initial query, wherein the augmented search results include the primary item, the set of associated items, and the intended setting AR image of the primary item with the set of associated items within the intended setting for use of the primary item, wherein the augmented search results are presented to the user via the UI device.

Other non-limiting examples provide one or more computer storage devices having a first computer-executable instructions stored thereon for providing intent-based augmented shopping guidance. When executed by a computer, the computer performs operations including obtaining initial search results generated by a search engine, the initial search results associated with an initial query received from a user interface (UI) device; identifying a primary item from the initial search results and an intended purpose associated with the primary item using the initial query and the initial search results; generating a set of associated items corresponding to the primary item and the intended purpose of the primary item using user-specific historical data and user-specific profile data, the set of associated items comprising at least one item or service to be used in conjunction with the primary item; creating an intended setting augmented reality (AR) image comprising a visual representation of the primary item and the set of associated items being used for their intended purpose within the intended setting; and generating augmented search results responsive to the initial query, wherein the augmented search results include the primary item, the set of associated items, and the intended setting AR image of the primary item with the set of associated items within the intended setting for use of the primary item, wherein the augmented search results are presented to the user via the UI device.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” only one of or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions operative by the processor to:
identify a primary item from an initial query received from a user interface (UI) device and item attributes associated with the primary item;
identify setting details associated with a setting depicted in an image obtained via the UI device using a computer vision (CV) model;
determine, using a machine learning (ML) model based at least on the item attributes and the setting details, a micro-level intent for the primary item and a macro-level intent for the primary item;
select, using the ML model, a plurality of recommended items for use in conjunction with the primary item, wherein the plurality of recommended items includes at least one micro-item belonging to a same or similar item-type as the primary item selected based on the micro-level intent and at least one macro-item belonging to an item-type outside of the item-type of the primary item selected based on the macro-level intent; and
present each of the plurality of recommended items via the UI device as a selectable option for including in a selection experience including the primary item.

2. The system of claim 1, wherein the computer-readable medium further stores instructions operative by the processor to:
determine a primary item location for the primary item in the setting based on the setting details; and
generate a modified image depicting the primary item at the primary item location of setting and present the modified image via the UI device.

3. The system of claim 2, wherein the computer-readable medium further stores instructions operative by the processor to:
detect a selection of a selectable option corresponding to one recommended item of the plurality of recommended items;
determine a recommended item location for the one recommended item based on the setting details; and
generate the modified image to include the one recommended item at the recommended item location of the setting.

4. The system of claim 2, wherein the modified image is presented as an augment reality (AR) image.

5. The system of claim 1, wherein the initial query includes the image and the primary item is identified from the image using the CV model.

6. The system of claim 5, wherein the computer-readable medium further stores instructions operative by the processor to:
identify a location associated with an image capture device generating the image; and
select the plurality of recommended items based at least on the location.

7. The system of claim 6, wherein the computer-readable medium further stores instructions operative by the processor to:
present, via the UI device, a primary location corresponding to a location of the primary item relative to the location where the image was captured; and
for each of the plurality of recommended items, present, via the UI device, a recommended location corresponding to a location of the recommended item relative to the location associated with the image capture device.

8. A method comprising:
identifying, by a processor, a primary item from an initial query received from a user interface (UI) device and item attributes associated with the primary item;
identifying, by the processor, setting details associated with a setting depicted in an image obtained via the UI device using a computer vision (CV) model;
determining, by the processor using a machine learning (ML) model based at least on the item attributes and the setting details, a micro-level intent for the primary item and a macro-level intent for the primary item;
selecting, by the processor using the ML model, a plurality of recommended items for use in conjunction with the primary item, wherein the plurality of recommended items includes at least one micro-item belonging to a same or similar item-type as the primary item selected based on the micro-level intent and at least one macro-item belonging to an item-type outside of the item-type of the primary item selected based on the macro-level intent; and
presenting, by the processor, each of the plurality of recommended items via the UI device as a selectable option for including in a selection experience including the primary item.

9. The method of claim 8, further comprising:
determining, by the processor, a primary item location for the primary item in the setting based on the setting details; and
generating, by the processor, a modified image depicting the primary item at the primary item location of setting and present the modified image via the UI device.

10. The method of claim 9, further comprising:
detecting, by the processor, a selection of a selectable option corresponding to one recommended item of the plurality of recommended items;
determining, by the processor, a recommended item location for the one recommended item based on the setting details; and
generating, by the processor, the modified image to include the one recommended item at the recommended item location of the setting.

11. The method of claim 9, wherein the modified image is presented as an augment reality (AR) image.

12. The method of claim 8, wherein the initial query includes the image and the primary item is identified from the image using the CV model.

13. The method of claim 12, further comprising:
identifying, by the processor, a location associated with an image capture device generating the image; and
selecting, by the processor, the plurality of recommended items based at least on the location.

14. The method of claim 12, further comprising:
presenting, via the UI device, a primary location corresponding to a location of the primary item relative to the location where the image was captured; and
for each of the plurality of recommended items, presenting, via the UI device, a recommended location corresponding to a location of the recommended item relative to the location associated with the image capture device.

15. A computer-readable medium storing instructions operative by a processor to:
identify a primary item from an initial query received from a user interface (UI) device and item attributes associated with the primary item;
identify setting details associated with a setting depicted in an image obtained via the UI device using a computer vision (CV) model;
determine, using a machine learning (ML) model based at least on the item attributes and the setting details, a micro-level intent for the primary item and a macro-level intent for the primary item;
select, using the ML model, a plurality of recommended items for use in conjunction with the primary item, wherein the plurality of recommended items includes at least one micro-item belonging to a same or similar item-type as the primary item selected based on the micro-level intent and at least one macro-item belonging to an item-type outside of the item-type of the primary item selected based on the macro-level intent; and
present each of the plurality of recommended items via the UI device as a selectable option for including in a selection experience including the primary item.

16. The computer-readable medium of claim 15, furthering storing instructions operative by the processor to:
determine a primary item location for the primary item in the setting based on the setting details; and
generate a modified image depicting the primary item at the primary item location of setting and present the modified image via the UI device.

17. The computer-readable medium of claim 16, further storing instructions operative by the processor to:
detect a selection of a selectable option corresponding to one recommended item of the plurality of recommended items;
determine a recommended item location for the one recommended item based on the setting details; and
generate the modified image to include the one recommended item at the recommended item location of the setting.

18. The computer-readable medium of claim 16, wherein the modified image is presented as an augment reality (AR) image.

19. The computer-readable medium of claim 15, wherein the initial query includes the image and the primary item is identified from the image using the CV model.

20. The computer-readable medium of claim 19, further storing instructions operative by the processor to:
identify a location associated with an image capture device generating the image; and
select the plurality of recommended items based at least on the location.
